(19) United States
(12) Patent Application Publication
(10) Pub. No.: US 2011/0056717 A1
(43) Pub. Date: Mar. 10, 2011

(54) SELF-CONTAINED PORTABLE ELECTRICAL APPLIANCE WITH LOCK-ON ELECTRIC POWER PACK

(75) Inventor: Jean-Christophe Herisse, Savigny Sur Orge (FR)

(73) Assignee: STANLEY WORKS (EUROPE) GMBH, Dubendorf (CH)

(21) Appl. No.: 12/935,412

(22) PCT Filed: Apr. 1, 2009
(86) PCT No.: PCT/FR2009/050556

§ 371 Date: Nov. 23, 2010

(30) Foreign Application Priority Data
Apr. 2, 2008 (FR) 08 52166

(51) Int. Cl. B25F 5/02

(52) U.S. Cl. 173/217

(57) ABSTRACT

A self-contained portable electrical appliance (10) includes:
an electrical unit (12);
an electric power pack (14);
the unit (12) including a handgrip (28) which extends in a handgrip direction Y-Y,
the handgrip (28) removably connecting the unit (12) and the pack (14) in a coupled position,
the handgrip (28) and the pack (14) including a first locking element (36) and a second locking element which are designed to lock together in the coupled position, the first locking element (36) being able to move between a rest position and an unlocked position. The first locking element (36) is able to move in terms of rotation between its locked and released position about an axis of rotation substantially parallel to the handgrip direction Y-Y.

The present invention concerns a self-contained portable electrical appliance, in particular a portable electric tool such as a screwdriver, bolter or drill, the appliance being of the type comprising:
an electrical unit;
an electric power pack comprising accumulators or batteries adapted to electrically power the electrical unit independently;

the electrical unit comprising a shell provided with a handgrip that extends in a handgrip extension direction Y-Y, said handgrip including a distal end comprising first connecting means,

the electric power pack including second connecting means adapted to cooperate with the first connecting means of the handgrip so as to removably connect the electrical unit and the electric power pack in a coupling position,

the handgrip and the electric power pack also respectively including first and second locking means, the first locking means being able to move in relation to the second locking means between a rest position and an unlocked position, such that, when the first locking means is in its rest position, the locking means locks, by mutual engagement, the electric power pack in relation to the handgrip in the coupling position, and that, when the first locking means is in its unlocked position, the first and second locking means are released from their mutual engagement,

the first locking means being connected to an actuator adapted to bring the first locking means into its unlocked position.

It is known from GB-A-2 425 899 to equip a self-contained portable electrical tool with a removable electric power pack, the foot of a distal end of the tool's handgrip having an elongated locking lever provided with a pushing end and a locking end. The lever makes it possible to manually uncouple the electric power pack and the handgrip of the electrical tool. The lever is able to move rotatingly in relation to a trunnion arranged at the foot substantially perpendicularly to the handgrip, between a locking position in which the end of the lever opposite the pushing end is engaged with a notch arranged at a face of the electric power pack, and a release position in which the locking end is disengaged from the notch of the electric power pack via action on the pushing end of the lever.

However, the design of such a locking lever does not allow optimal compactness of the foot of the tool's handgrip.

It is also known in the field of manufacturing self-contained portable electrical appliances to equip the electric power packs with one or two locking device(s) arranged on the outer shell of the electric power pack. However, this configuration of the locking device(s) is not easily accessible by the hand maintaining the appliance.

The invention aims to design a self-contained portable electrical appliance whereof the locking device is compact and ergonomic. Another aim of the invention is to simplify and decrease the manufacturing cost of the appliance.

To do this, the invention concerns a self-contained portable electrical appliance of the aforementioned type, characterized in that the first locking means is able to move in rotation between its rest and unlocked positions about an axis of rotation Y′-Y′ substantially parallel to the handgrip extension direction Y-Y.

According to other features:
the actuator includes a protruding gripping portion arranged through an opening formed in the handgrip;
the first locking means of the handgrip comprises a male portion and the second locking means of the electric power pack comprises a female portion, the male and female portions being mutually engaged in the locked coupling position;
the male portion comprises a retractable cam connected to a trunnion forming the axis of rotation Y′-Y′ of the first locking means, the cam protruding in relation to a recess of the handgrip, and the female portion comprises at least one notch arranged fixedly in a wall of the electric power pack complementary to the cam of the handgrip;
the distal end of the handgrip comprises a connecting base, and the electric power pack includes a receiving portion adapted to cooperate with the connecting base by sliding along a sliding direction X′-X′, the sliding direction X′-X′ being substantially perpendicular to the handgrip extension direction Y-Y;
the first and the second locking means respectively comprise a first and a second male portions cooperating one stopped against the other in the coupling position; and
the first male portion is able to move slidingly in a bowed blind cavity arranged inside the handgrip, and the second male portion is fixed protruding arranged outwardly from the electric power pack.

Other features are described in the dependent claims.

The invention and its advantages will be better understood upon reading the description that follows, provided solely as an example and done in reference to the appended drawings, in which:

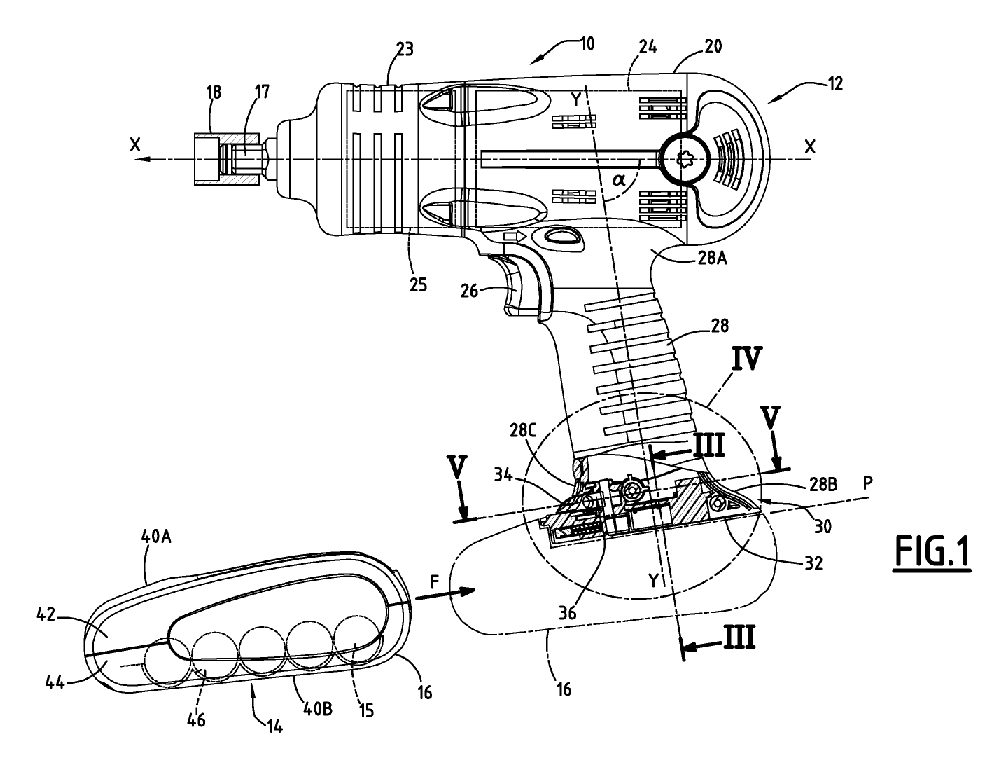

FIG. 1 is a side view of the self-contained portable electrical appliance according to the invention;

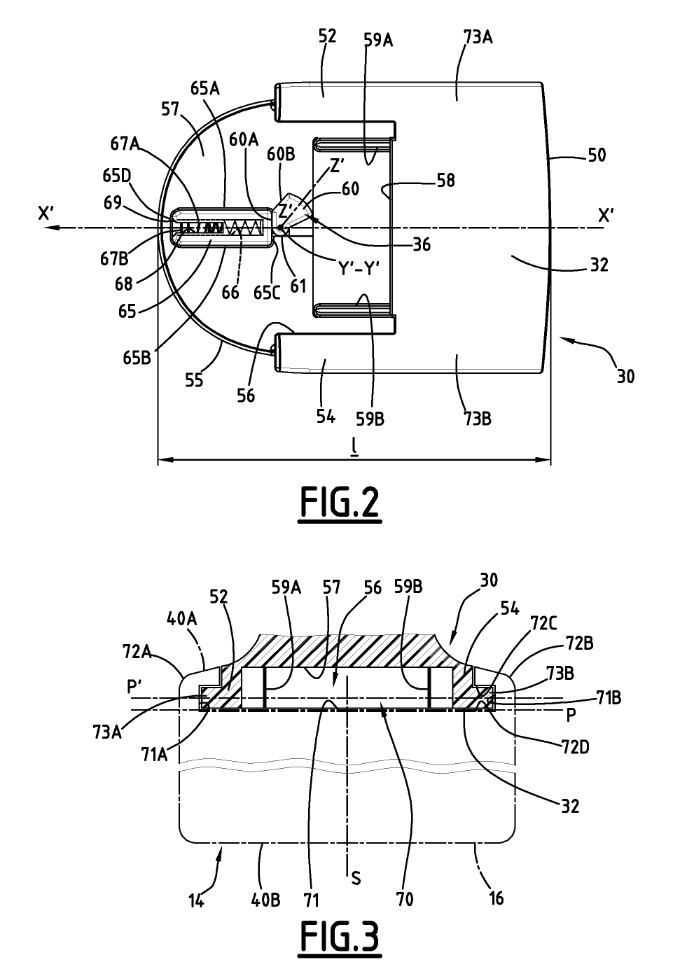

FIG. 2 is a bottom view of the foot of the handgrip of the portable electrical appliance of FIG. 1;

FIG. 3 is a transversal cross-sectional view of the foot of the handgrip of the electrical appliance along line III-III of FIG. 1;

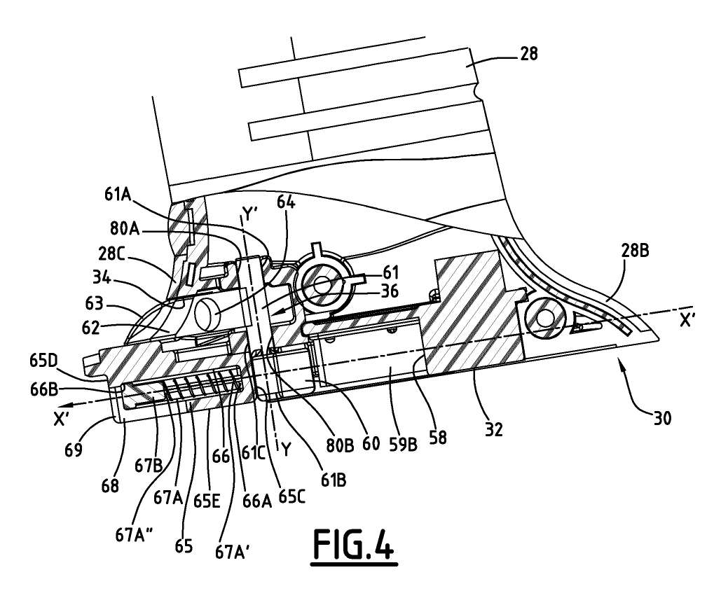

FIG. 4 is an enlarged longitudinal cross-sectional view of detail IV of FIG. 1 showing the foot of the handgrip of the electrical appliance;

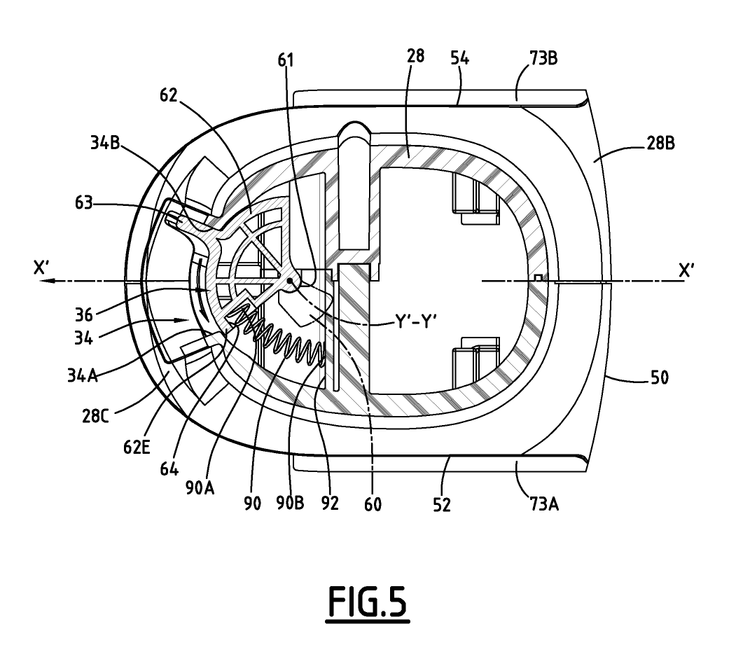

FIG. 5 is a cross-sectional view of the foot of the handgrip of the electrical appliance along line V-V of FIG. 1;

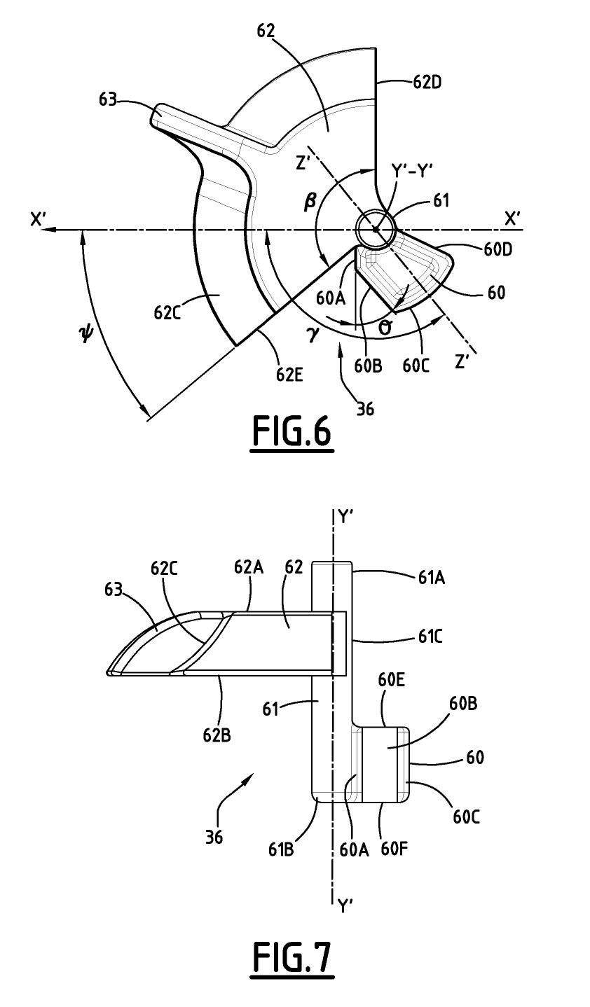

FIG. 6 is a top view of the locking device of the electrical appliance of FIG. 1;

FIG. 7 is a side view of the locking device of the electrical appliance of FIG. 1;

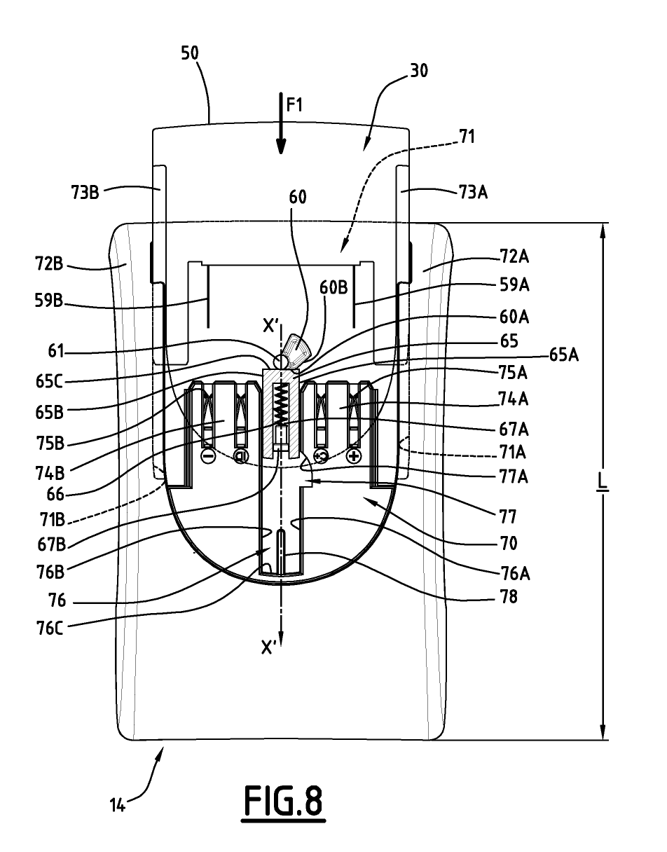

FIGS. 8 to 10 are top views of the electrical appliance showing different coupling and locking configurations between an electric power pack and the handgrip of the tool of FIG. 1;

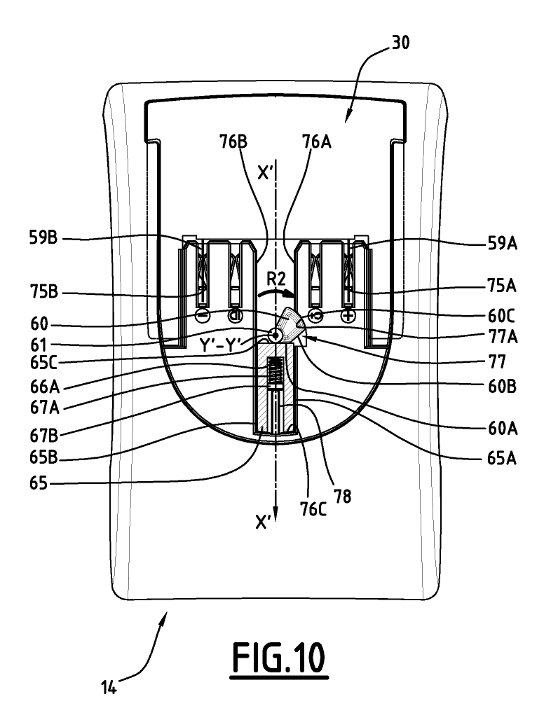

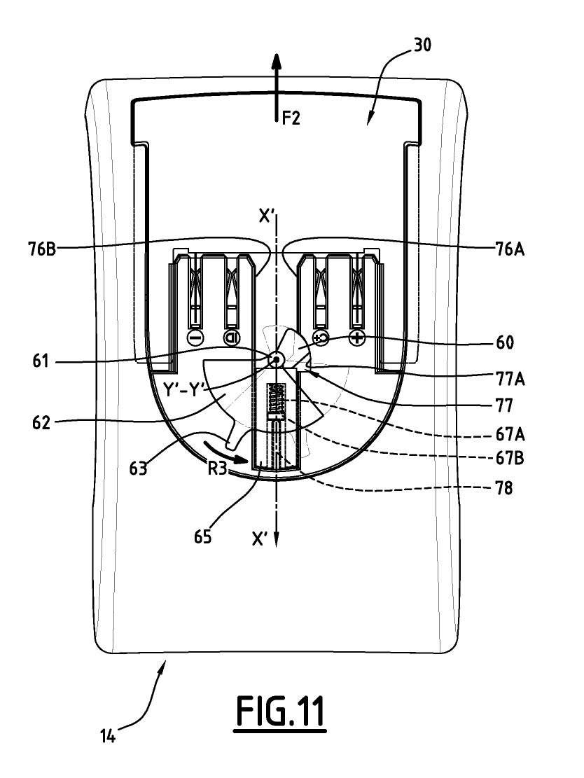

FIG. 11 is a top view of the electrical appliance showing the unlocked configuration between an electric power pack and the handgrip of the tool of FIG. 1;

FIG. 12 is a side view of another embodiment of the electrical appliance according to the invention;

FIG. 13 is a rear view of the electrical unit of the electrical appliance of FIG. 12;

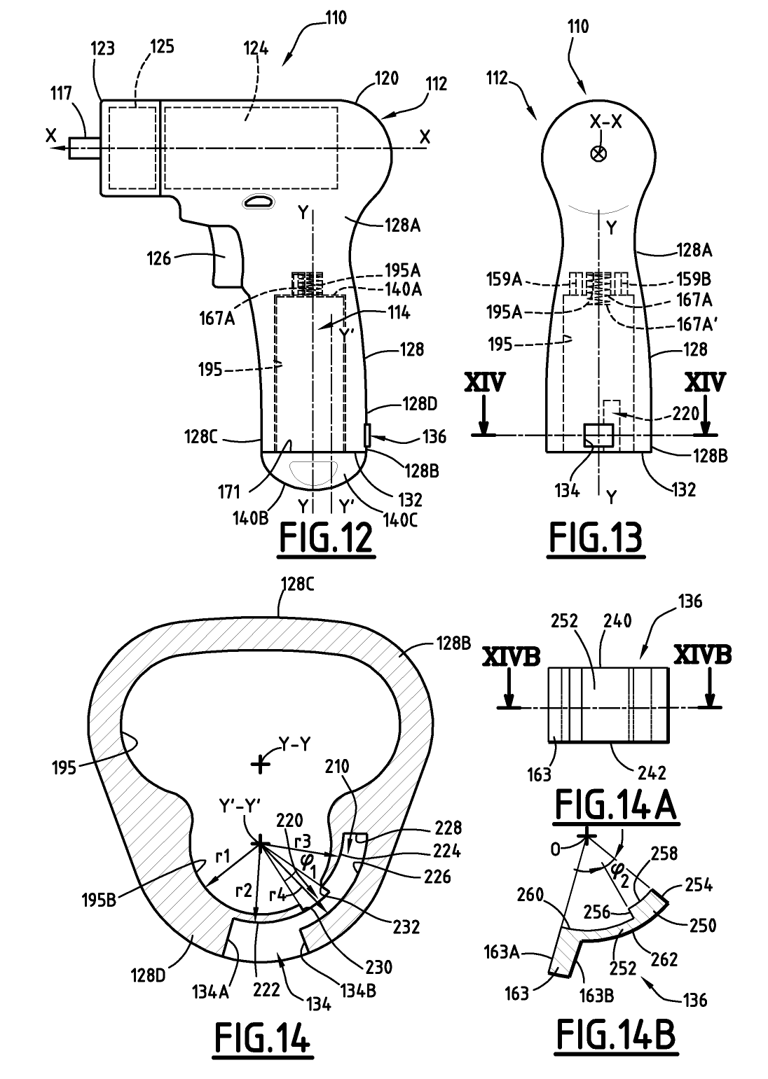

FIG. 14 is a transversal cross-sectional view along line XIV-XIV of FIG. 12;

FIG. 14A is a front view of the reversible locking device of the appliance of FIG. 12;

FIG. 14B is a transversal cross-sectional view along line XIVB-XIVB of FIG. 14A;

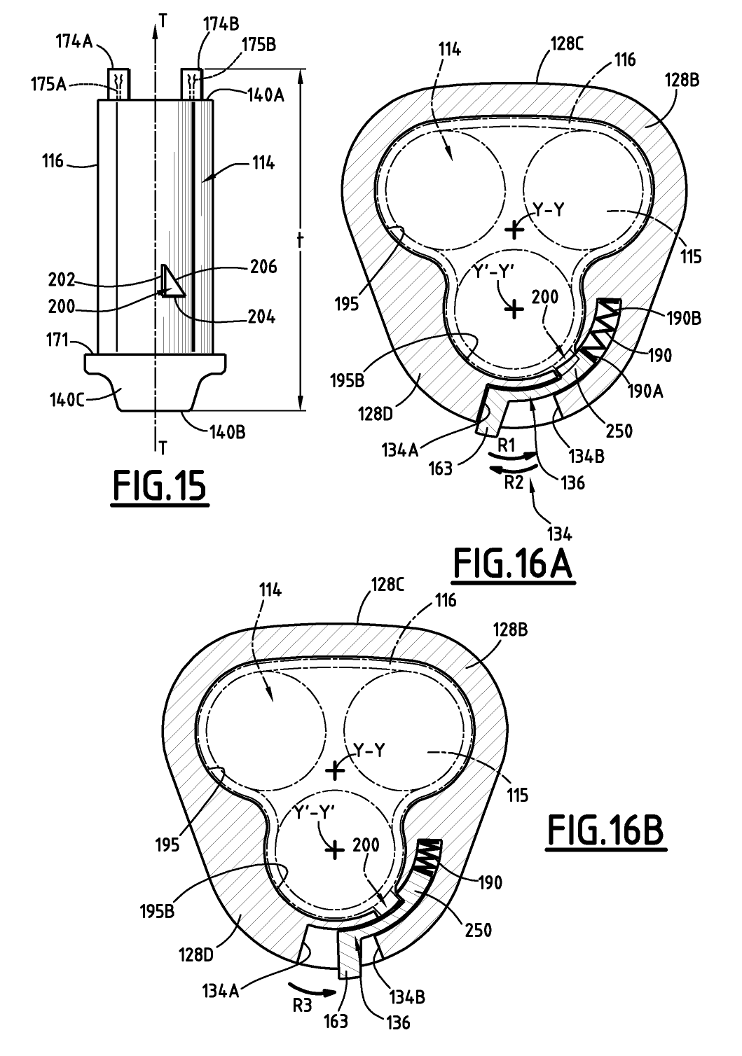

FIG. 15 is a rear view of the electric power pack of the electrical appliance of FIG. 12;

FIG. 16A is a transversal cross-sectional view similar to FIG. 14 showing the locking configuration between the electric power pack and the handgrip of the appliance of FIG. 12;

FIG. 16B is a view similar to FIG. 16A showing the unlocked configuration between the electric power pack and the handgrip of the appliance of FIG. 12.

FIG. 1 shows a self-contained portable electrical appliance 10 such as a bolter or an impact wrench according to a first embodiment. The appliance 10 comprises an electrical unit 12 extending along a longitudinal axis X-X oriented from right to left in FIG. 1. The electrical unit 12 is adapted to be connected to an electric power pack 14 and to operate independently in relation to the electric network owing to accumulators or rechargeable batteries 15. The latter are housed inside a housing 16 of the electric power pack 14.

In FIG. 1, the housing 16 is shown in solid lines in a detached position in relation to the electrical unit 12 and in broken lines in a coupled position in relation to the electrical unit 12. The latter position is obtained by a relative movement of the electric power pack 14 in relation to the electrical unit 12 along a direction illustrated by arrow F in FIG. 1.

When the electric power pack 14 is in the detached position in relation to the electrical unit 12, the appliance 10 is not in operating condition.

When the electric power pack 14 is coupled to the electrical unit 12 in a locked position, the appliance 10 is in operating condition. For this, the electrical unit 12 comprises a first locking means 36 (see below) adapted to cooperate with a second locking means 77 (see below) arranged on the electric power pack 14 in order to obtain coupling in the locked position.

The first locking means 36 is able to move between a so-called rest position when the electrical unit 12 and the electric power pack 14 are coupled in the locked position or when they are detached, and a so-called unlocked position when the user wishes to detach the electrical unit 12 and the electric power pack 14 from their locked coupling position.

The electrical unit 12 also comprises a working head 17 that has a male profile with a square transversal cross-section making it possible to drive a tool 18 such as a bush. The working head 17 is arranged outwardly in relation to an outer shell 20 of the electrical unit 12, the shell 20 forming a hollow envelope.

According to a traditional orientation of the appliance 10 as shown in FIG. 1, the front of the appliance 10 is situated on the side of the tool 18. In contrast, the rear of the appliance 10 is situated on the side opposite the tool 18 along the longitudinal axis X-X of the electrical unit 12, the axis X-X thus being oriented from back to front.

The terms “front” and “back” that will be used in the continuation of the description are understood according to that orientation. The terms “upper” and “lower” that will be used in the continuation of the description are understood according to the illustration of FIG. 1.

The electrical unit 12 also comprises a single-piece cap 23 fastened on the shell 20 so as to define a closed inner volume.

An electric motor 24 is housed inside the shell 20, the motor 24 being coupled to a transmission 25, itself housed inside the cap 23. The working head 17 protrudes in relation to the cap 23 and coupled to the transmission 25.

The electrical unit 12 is thus a driving part electrically controlled using a trigger 26 arranged at a connecting area between the shell 20 and a handgrip 28. The latter extends along a direction Y-Y substantially perpendicular to the longitudinal axis X-X of the electrical unit 12, the axis X-X and the direction Y-Y forming an angle α between 75° and 81°.

The handgrip 28 comprises a proximal end 28A connected to the shell 20, in particular in one piece therewith, and a distal free end 28B that is distant from the shell 20. A front portion 28C of the distal end 28B of the handgrip 28 is facing the trigger 26. The distal end 28B comprises a connecting base 30 having a flared shape allowing mechanical and electrical coupling between the electrical unit 12 and the electric power pack 14 for electrical powering of the motor 24.

The base 30 has a terminal face 32 substantially perpendicular to the direction Y-Y of the handgrip 28.

An opening 34, defined by two side walls 34A and 34B, is arranged at the front portion 28C of the distal end 28B of the handgrip 28 facing the trigger 26.

A reversible locking member 36 passes through the opening 34, the manual activation of the reversible locking member 36 making it possible, from its rest position, to detach the electrical unit 12 in relation to the electric power pack 14 when they are coupled in the locked position.

The housing 16 is symmetrical in relation to a median plane S (FIG. 3) and outwardly has a generally parallelepiped shape. It comprises an upper face 40A and a lower face 40B opposite the upper face 40A. The upper face 40A is oriented toward the working head 17 when the unit 12 and the power pack 14 are assembled. The lower face 40B serves as a base for the power pack 14 to be placed on a plane. The lower face 40B also serves as a base for the appliance 10 to vertically stand on a placement plane when the electrical unit 12 and the electric power pack 14 are assembled.

The housing 16 is made up of an upper shell 42 defining the upper face 40A and a lower shell 44 defining the lower face 40B, the shells 42 and 44 being assembled using suitable means.

The lower shell 44 has housings 46 intended to receive the accumulators or batteries 15, for example using Lithium ion (Li-Ion) technology, these being arranged substantially parallel to the lower face 40B.

In reference to FIG. 2, the connecting base 30 extends over a length l along a longitudinal axis X′-X′ oriented from back to front (from right to left in FIG. 2) and perpendicular to the axis Y′-Y′ of the handgrip 28. The axis X′-X′ is, consequently, substantially parallel to the axis X-X of the unit 12. The base 30 comprises, from back to front, a slightly convex back wall 50 defining the terminal face 32 that extends longitudinally over about forty percent of the length l. A left side wing 52 (shown in the upper portion of FIG. 2) and a right side wing 54 (shown in the lower portion of FIG. 2) extend the terminal face 32 and extend longitudinally beyond it over about thirty percent of the length l. A frontal wall 55 substantially in the form of an arc of circle having a radius equal to about thirty percent of the length l defines the connecting base 30 in the front portion.

A generally rectangular recess 56 open at the front is arranged between the side wings 52 and 54. A surface 57 substantially parallel to the terminal face 32 and offset in relation thereto toward the proximal end 28A of the handgrip 28 extends from a bottom wall 58 of the recess 56 perpendicular to the axis X′-X′ to the frontal wall 55 of the connecting base 30.

Two pins 59A and 59B are arranged protruding from the bottom wall 58 of the recess 56 toward the frontal wall 55. The pins 59A and 59B extend parallel to the axis X′-X′ on both sides thereof, on the side wings 52 and 54 sides, respectively. They are adapted to electrically connect the electrical unit 12 and the electric power pack 14.

The reversible locking member 36, the operation of which will be described later, is shown in FIG. 2 in the rest position corresponding to the configuration in which the electrical unit 12 and the electric power pack 14 are detached.

The reversible locking member 36 comprises a cam 60 arranged protruding in the recess 56 in front of the pins 59A and 59B. The cam 60 is connected to a cylindrical trunnion 61 having a circular transversal cross-section that extends along an axis Y′-Y′ parallel to the axis Y-Y. The cam 60 extends radially in relation to the trunnion 61 along a median axis Z′-Z′ (FIGS. 2 and 6) forming an angle γ of about 132° with the axis X′-X′ in the rest position of the reversible locking member 36.

The cam 60 is oriented toward the wing 52 of the connecting base 30. An actuator 62 connected to the trunnion 61 extends radially in relation thereto in a direction substantially opposite that of the cam 60.

The cam 60 has a transversal profile whereof the general flared shape includes a plurality of faces connected to each other (FIG. 6). A first planar face 60A connects the cam 60 to the trunnion 61 while diverging outwardly from the trunnion 61. A second elongated planar face 60B, substantially parallel to the axis Z′-Z′, extends the face 60A, the faces 60A and 60B forming an angle θ of about 42°. A third bowed face 60C with a radius centered on the axis Y′-Y′ extends substantially transversely to the face 60B and cuts the axis Z′-Z′. A fourth elongated planar face 60D connects the curved face 60C to the trunnion 61. An upper face 60E and a lower face 60F (FIG. 7) define the cam 60 along the axis Y′-Y′.

The trunnion 61 includes an upper end 61A and a lower end 61B between which is arranged an intermediate portion 61C (FIG. 7). The cam 60 is connected to the lower end 61B of the trunnion 61, preferably in one piece therewith.

The actuator 62 is connected to the intermediate portion 61C of the trunnion 61 at the upper half of the latter. The actuator 62 is preferably made in a single piece with the trunnion 61.

In side view (FIG. 7), the actuator 62 assumes a generally planar form defined by an upper face 62A, a lower face 62B and an inclined face 62C with a slightly concave profile, connecting the upper 62A and lower 62B faces. The inclined face 62C and the axis Y′-Y′ converge toward the upper end 61A of the trunnion 61.

In top view (FIG. 6), the actuator 62 is shown in its rest position in relation to the axis X′-X′. The actuator 62 generally assumes the shape of an angle sector defined by two straight radial walls 62D and 62E forming an angle β of about 130° between them, the face 62E angularly closest to the cam 60 and the axis X′-X′ forming an angle ψ of about 40°. An arc of circle shape defines the inclined face 62C.

A gripping protrusion 63 extends substantially radially and outwardly from the inclined face 62C of the actuator 62, in the extension of the upper 62A and lower 62B faces. The gripping protrusion 63 is arranged radially substantially on the right bisector of the angle β.

The face 62E of the actuator 62 also includes a receiving recess 64 (FIGS. 4 and 5) whereof the function will be described later.

In FIG. 2, the connecting base 30 also comprises a protuberance 65 with a generally parallelepiped shape protruding from the surface 57. The protuberance 65 includes two elongated side faces 65A and 65B parallel to the axis X′-X′, arranged on the side wings 52 and 54 side, respectively. The protuberance 65 also includes a rear face 65C and a front face 65D perpendicular to the axis X′-X′, as well as a lower face 65E (FIG. 4). The latter is arranged substantially in the same plane as the terminal face 32.

The protuberance 65 inwardly comprises a cylindrical bore 66 extending along the axis X′-X′ and including a rear stop 66A and a front stop 66B (FIG. 4). A first compression spring 67A is housed in the bore 66. The rear end 67A′ of the first spring 67A bears against the rear stop 66A. The front end 67A″ of the first spring 67A bears against a pusher 67B able to move longitudinally along the axis X′-X′. Under the effect of the bias from the first slightly compressed spring 67A, the pusher 67B bears against the front stop 66B.

The protuberance 65 also comprises a first slot 68 arranged in the lower face 65E, which extends along the axis X′-X′ over the forward half of the protuberance 65. A second slot 69 is arranged in the front face 65D of the protuberance 65 in the extension of the slot 68 and extends perpendicularly to the axis X′-X′. The slots 68 and 69 open in the bore 66.

Under the effect of a force tending to push the pusher 67B from the front toward the back, the latter is able to move from a rest position corresponding to its position bearing against the front stop 66B of the bore 66 to a position in which it moves toward the rear stop 66A of the bore 66 against the stress of the first spring 67A.

In FIG. 3, the upper face 40A of the electric power pack 14 comprises a receiving portion 70 extending over about the rear two thirds of the upper face 40A of the housing 16 measured along the length L (FIG. 8). The receiving portion 70 is adapted to receive, in a complementary manner, the connecting base 30 of the electrical unit 12.

The receiving portion 70 comprises a support surface 71 adapted to cooperate with the terminal face 32 of the connecting base 30 of the electrical unit 12 when the electrical unit 12 and the electric power pack 14 are coupled (FIGS. 8 to 10). The face 32 and the support surface 71 define a general assembly plane P between the electrical unit 12 and the electric power pack 14.

Guide grooves 71A and 71B are arranged respectively on side walls 72A and 72B of the receiving portion 70 of the electric power pack 14. The guide grooves 71A and 71B are adapted to cooperate with guide ribs 73A and 73B of conjugated shape arranged on the side wings 52 and 54, respectively, of the connecting base 30 of the electrical unit 12.

A middle guide plane P′, i.e. a guide plane situated midway between an upper guide face 72C and a lower guide face 72D of each guide groove 72, is thus arranged substantially parallel to the general assembly plane P, slightly offset in relation to the general assembly plane P toward the upper face 40A of the housing 16.

The receiving portion 70 comprises, in front of the support surface 71, a first and a second protuberances 74A and 74B (FIG. 8) arranged on both sides of the plane of symmetry of the housing 16 on the side walls 72A and 72B sides, respectively. The protuberances 74A and 74B are adapted to cooperate with the recess 56 of the connecting base 30. The protuberances 74A and 74B comprise a female electrical connector 75A with positive polarity and a female electrical connector 75B with negative polarity, respectively. The connectors 75A and 75B are adapted to be connected respectively to the pins 59A and 59B of the connecting base 30 in order to electrically power the electrical unit 12 from the electric power pack 14.

The receiving portion 70 also comprises a middle groove 76 (FIG. 8) that extends longitudinally and symmetrically on both sides of the middle plane of symmetry S of the receiving portion 70, the plane S coinciding with the axis X′-X′ when the receiving portion 70 and the connecting base 30 are assembled. The middle groove 76 separates the protuberances 74A and 74B.

The middle groove 76 is rearwardly opened facing the support surface 71 of the receiving portion 70. The middle groove 76 has dimensions adapted to allow, during coupling of the electric power pack 14 and the handgrip 28, the passage of the protuberance 65 of the connecting base 30 with sufficient clearance so as not to interfere with the guiding of the grooves 71A and 71B and the respective guide ribs 73A and 73B of the receiving portion 70 and the connecting base 30. The middle groove 76 comprises side walls 76A and 76B (FIGS. 8 to 11) extending parallel to the plane of symmetry S of the receiving portion 70 and a forward wall 76C substantially perpendicular to the plane of symmetry S of the receiving portion 70. The side walls 76A and 76B are arranged respectively on the protuberances 74A and 74B side.

A notch 77 (FIG. 8) is arranged in the side wall 76A. The notch 77 is positioned longitudinally at about mid-length of the middle groove 76 such that the cam 60 and the notch 77 cooperate during locking of the coupling of the electric power pack 14 and the handgrip 28, as will be described later. For this, the notch 77 has a partially bowed profile 77A with a shape complementary to the third face 60C of the cam 60.

A tab 78 (FIG. 8) is arranged longitudinally along the plane of symmetry S of the receiving portion 70 from the forward wall 76C of the groove 76 toward the notch 77. The dimensions of the tab 78 are adapted to cooperate with the slots 68 and 69 of the protuberance 65 of the connecting base 30 so as to come into contact with the pusher 67B biased by the first spring 67A of the connecting base 30 during coupling of the electric power pack 14 and the handgrip 28, as will be described later.

In FIG. 4, the front portion 28C of the distal end 28B of the handgrip 28 inwardly includes an upper bearing 80A and a lower bearing 80B. The upper end 61A of the trunnion 61 is in contact with the upper bearing 80A while the intermediate portion 61C of the trunnion 61 is in contact with the lower bearing 80B. The bearings 80A and 80B are preferably made in a single piece with the handgrip 28. The trunnion 61 is thus able to move rotatingly around its axis Y′-Y′.

The gripping protrusion 63 is arranged through the opening 34 formed in the front portion 28C of the distal end 28B of the handgrip 28. The gripping protrusion 63 is adapted to be handled by one finger chosen from the index, middle, ring or little finger of the hand surrounding the handgrip 28.

In FIG. 5, the actuator 62 is biased by a second compression spring 90 including a front end 90A and a rear end 90B. The front end 90A bears in the recess 64 arranged in the face 62E of the actuator 62. The rear end 90B bears against a transversal inner wall 92 of the handgrip 28.

The second spring 90 biases the actuator 62 in the stable rest position of the reversible locking member 36. The second spring 90 is weakly compressed and the gripping protrusion 63 of the actuator 62 abuts against the side wall 34B of the opening 34 arranged in the front portion 28C of the handgrip 28 (FIG. 5) on the side wing 54 side of the connecting base 30. The actuator 62 being in its rest position, the first face 60A of the cam 60 is facing the rear face 65C of the protuberance 65 (FIGS. 2 and 8), distant therefrom with a small assembly clearance. As will be described later, under certain conditions, these two faces are brought into contact with each other.

The operation of the lock-on coupling of the electric power pack 14 and the handgrip 28 will now be described as well as the unlocking operation.

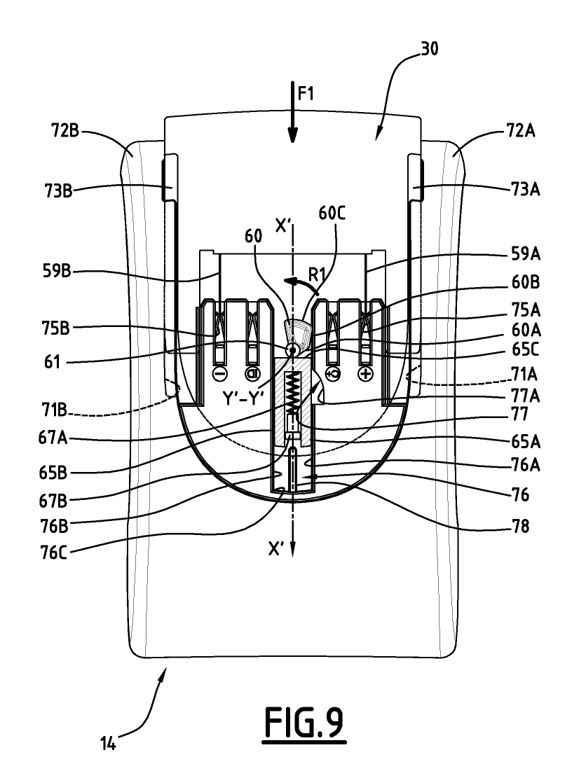

FIGS. 8 and 9 show the electric power pack 14 and the handgrip 28 in their coupled configuration corresponding to the transition between their detached position and their lock-on coupling position.

In reference to FIG. 8, the connecting base 30 is slidingly mounted in the receiving portion 70 along the direction shown by arrow F1.

The grooves 71A and 71B slidingly guide the conjugated ribs 73A and 73B. The protuberance 65 of the connecting base 30 is positioned inside the middle groove 76. The cam 60 is in its rest position.

The pins 59A and 59B are aligned with the connectors 75A and 75B, respectively. Likewise, the pusher 67B is aligned with the tab 78.

In reference to FIG. 9, the relative sliding movement between the electric power pack 14 and the handgrip 28 along the direction illustrated by arrow F1 is continued.

The protuberance 65 continues its travel inside the middle groove 76 toward the tab 78. The second face 60B of the cam 60 is in contact with the wall 76B of the groove 76, while the first face 60A is no longer facing the rear face 65C of the protuberance 65 of the base 30 in relation to the configuration of FIG. 8. The cam 60 is retracted in the groove 76 by counterclockwise rotation around the axis Y′-Y′ along arrow R1 against the stress of the second spring 90, which is compressed.

The pins 59A and 59B are in contact with the connectors 75A and 75B, respectively. The pusher 67B is facing the tab 78 at a small distance therefrom.

FIG. 10 illustrates the electric power pack 14 and the handgrip 28 in the configuration corresponding to their lock-on coupling position.

In reference to FIG. 10, the relative sliding movement between the electric power pack 14 and the handgrip 28 is finished.

The protuberance 65 of the connecting base 30 is abutting against the forward wall 76C of the receiving portion 70. Under the detent effect of the second spring 90, the third face 60C of the cam 60 is engaged with the conjugated partially bowed profile 77A of the notch 77. The cam 60 has returned to its rest position by clockwise rotation around the axis Y′-Y′ along arrow R2. The first face 60A of the cam 60 is again facing the rear face 65C of the protuberance 65 of the connecting base 30.

The pins 59A and 59B are fully engaged with the connectors 75A and 75B, respectively.

In the lock-on coupling configuration of the electrical unit 12 and the electric power pack 14, the tab 78 is completely introduced into the slots 68 and 69. During the coupling movement, the tab 78 acts on the pusher 67B such that it moves longitudinally in the bore 66 toward the rear stop 66A of the bore 66. The relative movement between the pusher 67B and the tab 78 results in compressing the first compression spring 67A.

In response, the latter tends to detend and exerts a stress tending to separate the connecting base 30 and the receiving portion 70. The cam 60 being engaged with the notch 77, this separation is prevented. The connecting base 30 and the electric power pack 14 are coupled in relation to each other in the locked position.

In case of fall of the appliance 10, the electrical unit 12 and the electric power pack 14 being coupled in the locked position, the energy of the shock must not be completely dissipated by the trunnion 61. For this, because the first face 60A of the cam 60 is facing the rear face 65C of the protuberance 65 at a very small distance, the cam 60 is adapted, in case of shock, to abut against the protuberance 65 of the connecting base 30. Thus, in case of shock, the trunnion 61 does not undergo significant stresses.

FIG. 11 shows the electric power pack 14 and the handgrip 28 in the configuration corresponding to their lock-on coupling position.

In reference to FIG. 11, the user wishes to detach the electric power pack 14 and the handgrip 28 of the electrical unit 12 in relation to each other.

To do this, the user voluntarily and manually moves the actuator 62 from a first so-called rest position corresponding to the configuration in which the cam 60, shown in solid lines, is engaged in the notch 77 toward a second so-called unlocked position corresponding to the configuration in which the cam 60, shown in broken lines, is disengaged in relation to the notch 77 and retracted into the middle groove 76 at the rear of the protuberance 65.

To do this, the user grasps the gripping protrusion 63 of the actuator 62 and acts on it with a rotational movement in the counterclockwise direction in FIG. 11 in relation to the axis Y′-Y′ by an angular value in the vicinity of 37° along arrow R3. This operation is done against the stress of the second compression spring 90.

In the configuration corresponding to the so-called unlocked position in which the cam 60 is disengaged in relation the notch 77 and retracted in the middle groove 76, the first spring 67A detends and tends to separate the connecting base 30 and the receiving portion 70 along a longitudinal sliding movement shown by arrow F2.

This ejection movement of the electric power pack 14 in relation to the handgrip 28 continues until the pusher 67 resumes its rest position bearing against the front stop 66B.

Once the first spring 90 is detended and the relative separation movement is obtained, the cam 60 is no longer facing the notch 77, which allows the user to release the gripping protrusion 63. When the cam 60 is no longer in contact with the middle groove 76, the second spring 90 detends and the actuator 62 resumes its initial so-called rest position corresponding to the configuration in which the cam 60 is in its rest position.

The user manually uncouples the electrical unit 12 and the electric power pack 14 for a new coupling cycle with locking and detachment.

FIGS. 12 to 16B show a second embodiment. In this embodiment, the elements having the same functions as in the first embodiment illustrated in FIGS. 1 to 11 use the same numerical references as the first embodiment increased by 100.

The second embodiment differs from the first embodiment in that the electric power pack 114 is partially inserted in the handgrip 128 of a bolter or impact wrench 110 when the electric power pack 114 and the electrical unit 112 are in the coupling position.

When the electric power pack 114 is in the detached position in relation to the electrical unit 112, the appliance 110 is not in operating condition.

When the electric power pack 114 is coupled to the electrical unit 112 in a locked position, the appliance 110 is in operating condition. For this, the electrical unit 112 comprises a first locking means 136 (see below) adapted to cooperate with a second locking means 200 (see below) arranged on the electric power pack 114 in order to obtain coupling in the locked position.

The first locking means 136 is able to move between a first so-called rest position when the electrical unit 112 and the electric power pack 114 are coupled in the locked position or when they are detached, and a second so-called unlocking position when the user wishes to detach the electrical unit 112 and the electric power pack 114 from their locked coupling position.

In reference to FIG. 12, the sliding movement between the locking position of the electric power pack 114 in relation to the handgrip 128 and the detachment position of these two elements is substantially parallel to the axis Y-Y of the handgrip 128.

The handgrip 128 of the electrical unit 112 comprises a rear portion 128D arranged at the distal end 128B on the side opposite the trigger 126 in relation to the axis Y-Y.

The handgrip 128 also comprises a recess 195 adapted to partially receive the housing 116 of the electric power pack 114 with a shape adjustment of the housing 116 in relation to the recess 195. The recess 195 has a transversal cross-section and a length complementary to those of the housing 116 in which the accumulators or batteries 115 are housed (FIGS. 16A and 16B).

The recess 195 extends along a direction substantially parallel to the axis Y-Y of the handgrip 128. The recess 195 comprises a back wall 195A arranged near the proximal end 128A of the handgrip 128 and opens, opposite the back wall 195A, in the terminal face 132 of the distal end 128B of the handgrip 128.

A first compression spring 167A is connected to the back wall 195A and comprises a free end 167A′ (FIG. 13). The first spring 167A is adapted to be compressed in a direction substantially parallel to the axis Y-Y of the handgrip 128 when the electric power pack 114 and the handgrip 128 of the electrical unit 112 are in the lock-on coupled position.

The first spring 167A, in the compressed state, tends to eject the electric power pack 112 outside the recess 195. A reversible locking member 136 passes through a quadrilateral radial opening 134 (FIG. 13) arranged outwardly in the rear portion 128D of the distal end 128B of the handgrip 128. The reversible locking member 136 prevents the ejection by locking the electric power pack 114 in the coupling position inside the recess 195.

The electric power pack 114, illustrated vertically in FIG. 15, extends along a longitudinal axis T-T oriented from bottom to top. The housing 116 includes an upper face 140A from which two protuberances 174A and 174B protrude longitudinally housing electrical connectors 175A and 175B, respectively.

The housing 116 also comprises a shoulder 171 successively defining, toward the bottom, a gripping portion 140C extended by a lower face 140B. The shoulder 171 is arranged radially protruding in relation to the longitudinal axis T-T in the lower third of the housing 116 measured in relation to the height t along the axis T-T of the electric power pack 114.

In the lock-on coupling configuration of the electrical unit 112 and the electric power pack 114, the shoulder 171 is adapted to bear against the terminal face 132 of the handgrip 128 and the gripping portion 140C and the lower face 140B are arranged outwardly in relation to the handgrip 128.

A boss 200 extends outwardly protruding transversely in relation to the longitudinal axis T-T in the lower half of the housing 116 measured in relation to the height t of the housing 116.

The boss 200 is arranged above the shoulder 171 radially in relation to an accumulator or a battery 115 having a circular transversal cross-section arranged longitudinally in relation to the axis T-T.

The boss 200 comprises an elongated planar side face 202 substantially parallel to the longitudinal axis T-T, an elongated lower planar face 204 substantially perpendicular to the longitudinal axis T-T and an elongated inclined planar face 206 connecting the side face 202 and the lower face 204. The faces 202, 204, 206 form a protrusion having the general shape of a right-angled triangle.

When the electric power pack 114 is coupled in the locked position in relation the electrical unit 112, the reversible locking member 136 is arranged between the terminal face 132 of the distal end 128B of the handgrip 128 and the lower face 204 of the boss 200 of the electric power pack 114.

In reference to FIG. 14, the recess 195 of the handgrip 128 comprises a transversal cross-section made up of three concave arc of circle lobes. One of the lobes 195B is centered on an axis Y′-Y′ parallel to the axis Y-Y of the handgrip 128 and offset on the side of the rear portion 128D of the handgrip 128. The lobe 195B comprises a circular profile whereof the radius r1 is centered on the axis Y′-Y′.

The rear portion 128D of the handgrip 128 comprises, facing the radial opening 134 of the distal end 128B, a bowed inner blind cavity 210 arranged in the wall of the lobe 195B. The inner blind cavity 210 extends over a height along the axis Y-Y substantially corresponding to that of the radial opening 134 and communicates therewith.

A longitudinal groove 220 (FIG. 13) extends, from the terminal face 132, substantially parallel to the axis Y-Y along the sliding direction of the electric power pack 114 in relation to the recess 195. The longitudinal groove 220 opens in the inner blind cavity 210 and extends longitudinally along the axis Y-Y beyond the radial opening 134 (FIG. 13). The longitudinal groove 220 is adapted to slidingly receive the boss 200 of the housing 116 of the electric power pack 114. The longitudinal groove 220 includes two radial walls 230 and 232 in relation to the axis Y-Y′ that form an angle φ1 of about 30° between them.

The outer opening 134 is defined by a left radial wall 134A and a right radial wall 134B and a circular wall 222 whereof the radius r2 is centered on the axis Y′-Y′, the radius r2 being greater than the radius r1.

The bowed inner blind cavity 210 is defined by a first inner wall 224 whereof the radius r3 is centered on the axis Y′-Y′ and a second inner wall 226 whereof the radius r4 is also centered on the axis Y′-Y′. The radius r4 is larger than the radii r2 and r3. The radius r2 is larger than the radius r3, the latter being larger than the radius r1. The bowed inner blind cavity 210 is defined by a bottom wall 228 arranged radially in relation to the axis Y′-Y′.

In reference to FIG. 14A, the reversible locking member 136 comprises an upper face 240 and a lower face 242.

In reference to FIG. 14B, the transversal cross-section of the reversible locking member 136 comprises a profile adapted to slide in relation to the respective profiles of the outer radial opening 134 and the bowed inner blind cavity 210 so as to selectively cover the longitudinal groove 220.

For this, the reversible locking member 136 extends along an angle sector with apex ◯ and about 75°. It comprises a gripping protrusion 163 outwardly radial in relation to the apex ◯ and defined by two radial walls 163A and 163B. A locking block 250 is arranged opposite the gripping protrusion 163 and extends inwardly radially in relation to the apex ◯.

An intermediate actuator 252 connects the gripping protrusion 163 and the locking block 250. A right radial planar face 254 and a left radial planar face 256 radially define the locking block 250 and form an angle φ2 between them, the latter being slightly larger than the angle φ1 formed by the radial walls 230 and 232 of the inner longitudinal groove 220. A bowed face 258 centered in ◯ and the radius of which is equal to the radius r3, connects the radial faces 254 and 256 of the locking block 250. Two bowed faces 260 and 262 inwardly and outwardly, respectively, define the intermediate actuator 252 of the reversible locking member 136 in relation to the apex ◯. The face 260 is centered in ◯ and has a radius equal to the radius r2. The face 262 is centered in ◯ and has a radius equal to the radius r4.

Preferably, the reversible locking member 136 is formed in a single piece.

The walls 222, 224, and 226 arranged in the rear portion 128D of the handgrip 128 are adapted to slidingly guide the faces 260, 258 and 262, respectively, of the reversible locking member 136 along an arc of circle centered on the axis Y′-Y′. The reversible locking member 136 thus moves in rotation in relation to the axis Y′-Y′.

In reference to FIGS. 16A and 16B, the bowed inner blind cavity 210 houses a second compression spring 190 whereof the front end 190A bears against the outer radial face 254 of the locking block 250 of the reversible locking member 136 and whereof the rear end 190B bears against the radial bottom face 228 of the bowed inner blind cavity 210 of the handgrip 128.

In reference to FIG. 16A, the reversible locking member 136 is in its rest position. The second spring 190 is detended and biases the reversible locking member 136 such that the gripping protrusion 163 abuts against the left radial wall 134A of the outer radial opening 134 of the handgrip 128 farthest from the bottom radial face 228 and the locking block 250 covers the inner longitudinal groove 220.

This configuration corresponds to that in which the electrical unit 112 and the power pack 114 are detached or coupled in the locking position.

When the electrical unit 112 and the power pack 114 are detached and the user wishes to couple them, the user introduces the electric power pack 114 into the recess 195 of the handgrip 28 through a relative sliding movement along axis Y-Y.

The boss 200 is dimensioned so that it slides longitudinally in the inner groove 220 when the user introduces the electric power pack 114 into the recess 195. The side planar face 202 of the boss 200 is adapted to be longitudinally aligned with the radial face 230 of the inner longitudinal groove 220 farthest from the radial bottom face 228.

When the user continues the introduction of the electric power pack 114, the inclined face 206 of the boss 200 comes into contact with the locking block 250 of the reversible locking member 136. When the introduction continues, the reversible locking member 136 is moved inside the bowed inner blind cavity 210 against the stress of the second compression spring 190, the face 206 forming a cam for the boss 200. The reversible locking member 136 is moved in rotation around the axis Y′-Y′ in the counterclockwise direction shown by arrow R1 of FIG. 16A.

When the boss 200 is arranged longitudinally along the axis Y-Y such that the lower face 204 is facing the upper face 240 of the reversible locking member 136, the second spring 190 detends and biases the reversible locking member 136 such that the reversible locking member 136 moves in rotation in relation to the axis Y′-Y′ in a clockwise direction illustrated by the arrow R2 of FIG. 16A and returns to its rest position. The locking block 250 again covers the inner longitudinal groove 220. The electrical unit 112 and the electric power pack 114 are coupled in the locking position.

In the lock-on coupling configuration, the boss 200 of the electric power pack 114 is blocked in the longitudinal position along axis Y-Y. The electric power pack 114 abuts axially in the recess 195 and the upper face 140C of the housing 116 compresses the first compression spring 167A. The pins 159A and 159B are in contact respectively with the connectors 175A and 175B in order to electrically power the electrical unit 112.

When the user wishes to detach the electric power pack 114 in relation to the electrical unit 112 from their locking coupling configuration, the user uses the gripping protrusion 163 that is arranged through the outer radial opening 134 arranged in the rear portion 128D of the handgrip 128. The gripping protrusion 163 is adapted to be handled by the thumb of the hand whereof the palm surrounds the handgrip 128.

The user manually and voluntarily moves the reversible locking member 136 in rotation around the axis Y′-Y′ in the counterclockwise direction illustrated by the arrow R3 shown in FIG. 16B.

For this, the user grasps the gripping protrusion 163 and moves it toward the right radial wall 134B of the outer opening 134, the wall 134B being closest to the bottom wall 228 of the inner blind cavity 210. The locking block 250 slides inside the bowed inner blind cavity 210 against the stress of the second spring 190. The locking block 250 releases the inner longitudinal groove 220.

The user maintains the stress on the gripping protrusion 163 along the arrow R3. The first compression spring 167A that is compressed, biases the electric power pack 114 so as to separate it from the electrical unit 112 by an ejection effect. Under the detent effect of the first spring 167A, the boss 200 slides along the inner longitudinal groove 220. When the electric power pack 114 is sufficiently removed from the handgrip 128, the boss 200 is positioned outside the inner longitudinal groove 220. The user relaxes the stress on the gripping protrusion 163 such that the reversible locking member 136 returns to its rest position for a new coupling cycle with locking and detachment.

In the preceding, the appliance was described in the form of a bolter or impact wrench. However, the present invention applies to other types of appliances such as a screwdriver or drill.

Owing to the invention, the self-contained portable electrical appliance has a compact and ergonomic locking device, inserted in the handgrip. The manufacture thereof is simple and economical.

1. A self-contained portable electrical appliance (10; 110), in particular a portable electrical tool such as a screwdriver, bolter or drill, the appliance being of the type comprising:
an electrical unit (12; 112);
an electric power pack (14; 114) comprising accumulators or batteries (15; 115) adapted to electrically power the electrical unit (12; 112) independently;
the electrical unit (12; 112) comprising a shell (20; 120) provided with a handgrip (28; 128) that extends in a handgrip extension direction Y-Y, said handgrip including a distal end (28B, 128B) comprising first connecting means (30; 195),
the electric power pack including second connecting means (70; 116) adapted to cooperate with the first connecting means (30; 195) of the handgrip (28; 128) so as to removably connect the electrical unit (12; 112) and the electric power pack (14; 114) in a coupling position,
the handgrip (28; 128) and the electric power pack (14; 114) also respectively including first (36; 136) and second (77; 200) locking means, the first locking means (36; 136) being able to move in relation to the second locking means between a rest position and an unlocked position, such that, when the first locking means is in its rest position, the locking means locks, by mutual engagement, the electric power pack (14; 114) in relation to the handgrip (28; 128) in the coupling position, and that, when the first locking means is in its unlocked position, the first (36; 136) and second (77; 200) locking means are released from their mutual engagement,
the first locking means (36; 136) being connected to an actuator (62; 252) adapted to bring the first locking means (36; 136) into its unlocked position,
the first locking means (36; 136) being able to move in rotation between its rest and unlocked positions about an axis of rotation Y′-Y′ substantially parallel to the handgrip extension direction Y-Y,
characterized in that the actuator (62; 252) includes a protruding gripping portion (63; 163) arranged through an opening (34; 134) formed in the handgrip (28; 128).

2. The portable electrical appliance according to claim 1, characterized in that the actuator (62; 252) is connected exclusively mechanically, preferably rotatingly, to the first locking means (36; 136), so as to be able to drive the first locking means (36; 136) along the axis of rotation Y′-Y′.

3. The portable electrical appliance according to claim 1, characterized in that the actuator (62; 252) is inserted in the distal end (28B; 128B) of the handgrip (28; 128).

4. The portable electrical appliance according to claim 1, characterized in that the opening (34) is arranged on the side (128C) of the handgrip that is surrounded by the index, middle, ring and little fingers of the hand when said hand maintains the handgrip (28) in relation to the handgrip extension direction Y-Y, so as to make the protruding gripping portion (63) accessible by one of the fingers of said hand, preferably the index, middle or ring finger.

5. The portable electrical appliance according to claim 1, characterized in that the opening (134) is arranged on the side (128D) of the handgrip (128) that is surrounded by the palm of the hand when said hand maintains the handgrip (128), so as to make the protruding gripping portion (163) accessible to the thumb of the hand maintaining the handgrip.

6. The portable electrical appliance according to claim 1, characterized in that the first locking means (36) of the handgrip (28) comprises a male portion and the second locking means (77) of the electric power pack (14) comprises a female portion, the male and female portions being mutually engaged in the locked coupling position.

7. The portable electrical appliance according to claim 6, characterized in that the male portion comprises a retractable cam (60) connected to a trunnion (61) forming the axis of rotation Y′-Y′ of the first locking means (36), the cam (60) protruding in relation to a recess (56) of the handgrip (28), and in that the female portion comprises at least one notch (77) arranged fixedly in a wall (76A) of the electric power pack (14) complementary to the cam (60) of the handgrip (28).

8. The portable electrical appliance according to claim 7, characterized in that the actuator (62) is made in a single piece with the trunnion (61) forming the axis of rotation and the cam (60).

9. The portable electrical appliance according to claim 1, characterized in that the distal end (28B) of the handgrip (28) comprises a connecting base (30), and in that the electric power pack (14) includes a receiving portion (70) adapted to cooperate with the connecting base by sliding along a sliding direction X′-X′, the sliding direction X′-X′ being substantially perpendicular to the handgrip extension direction Y-Y.

10. The portable electrical appliance according to claim 1, characterized in that the first (136) and the second (200) locking means respectively comprise a first and a second male portions cooperating one stopped against the other in the coupling position.

11. The portable electrical appliance according to claim 10, characterized in that the first male portion (136) is able to move slidingly in a bowed blind cavity (210) arranged inside the handgrip (128), and in that the second male portion (200) is fixed protruding arranged outwardly from the electric power pack (114).

12. The portable electrical appliance according to claim 10, characterized in that the handgrip (128) has a recess (195) adapted to partially receive the electric power pack (114), the latter sliding substantially parallel to the handgrip extension direction Y-Y.

13. The portable electrical appliance according to claim 1, characterized in that a biasing means (90; 190) biases one among the first (36; 136) and second (77; 200) locking means toward a mutual engagement with the other among the first (36; 136) and second (77; 200) locking means, when they are in the coupling position.

14. The portable electrical appliance according to claim 1, characterized in that a driving part housed in a shell (20; 120) of the appliance (10; 110) includes an electric motor (24; 124) coupled to a transmission (25; 125), itself adapted to drive a working head (17; 117) of the electrical unit (12) and extends along a driving part extension direction X-X substantially perpendicular to the handgrip extension direction Y-Y.

15. The portable electrical appliance according to claim 1, characterized in that the appliance includes an ejection device (65, 66, 67A, 67B, 68, 69, 78; 140A, 167A, 195A) adapted to uncouple the first (30; 195) and the second (70; 116) connecting means so as to separate the electric power pack (14; 114) from the electrical unit (12; 112) when the first locking means (36; 136) is brought from its rest position to its unlocked position.
